(19) United States
(12) Patent Application Publication
(10) Pub. No.: US 2025/0070307 A1
(43) Pub. Date: Feb. 27, 2025

(54) ELASTIC SHEET FOR ALL-SOLID-STATE BATTERY AND ALL-SOLID-STATE BATTERY INCLUDING SAME

(71) Applicant: SAMSUNG SDI CO., LTD., Yongin-si (KR)

(72) Inventors: Dongho Koo, Yongin-si (KR); Jaehwan Ha, Yongin-si (KR); Juyun Kim, Yongin-si (KR); Yujin Kang, Yongin-si (KR)

(21) Appl. No.: 18/640,112

(22) Filed: Apr. 19, 2024

(30) Foreign Application Priority Data
Aug. 22, 2023 (KR) 10-2023-0110006

(51) Int. Cl. H01M 10/6554; H01M 10/0562; H01M 10/0565; H01M 10/42

(52) U.S. Cl. CPC H01M 10/6554; H01M 10/0562; H01M 10/0565; H01M 10/4235; H01M 2300/0071; H01M 2300/008

(57) ABSTRACT

Disclosed are an elastic sheet for an all-solid-state battery and an all-solid-state battery including the same. The elastic sheet includes a plate-shaped polymer with an aspect ratio of about 1 to about 5 and a thickness of about 0.2 μm to about 4 μm; and a binder. The all-solid-state battery includes a positive electrode, a negative electrode, a solid electrolyte layer between the positive electrode and the negative electrode, and an elastic sheet. The elastic sheet includes a plate-shaped polymer with an aspect ratio of about 1 to about 5 and a thickness of about 0.2 μm to about 4 μm, and a binder, positioned on outside of at least one of the positive electrode and the negative electrode.

### CROSS-REFERENCE TO RELATED APPLICATION

This application claims priority to and the benefit of Korean Patent Application No. 10-2023-0110006 filed in the Korean Intellectual Property Office on Aug. 22, 2023, the entire contents of which are incorporated herein by reference.

### BACKGROUND

### 1. Field

Embodiments of this disclosure relate to an elastic sheet for an all-solid-state battery and an all-solid-state battery including the same.

### 2. Description of the Related Art

Recently, with the rapid spread of electronic devices such as mobile phones, laptop computers, and electric vehicles using batteries, the demand for small, lightweight, and relatively high-capacity rechargeable batteries is rapidly increasing.

As such, the development of an all-solid-state battery using a lithium metal as a negative electrode has progressed. An all-solid-state battery refers to a battery in which all materials are solid, in a non-limiting example, a battery using a solid electrolyte.

### SUMMARY

Embodiments include an elastic sheet for an all-solid-state battery. The elastic sheet includes a plate-shaped polymer with an aspect ratio of about 1 to about 5 and a thickness of about 0.2 μm to about 4 μm; and a binder.

The aspect ratio may be about 1.1 to about 4.5.

The thickness may be about 0.3 μm to about 2.5 μm.

The plate-shaped polymer includes polyethylene particles.

The plate-shaped polymer may have a size of about 1 μm to about 8 μm.

An amount of the plate-shaped polymer may be about 10 wt % to about 70 wt %, based on a total weight of the elastic sheet.

The elastic sheet may further include a flame-retardant ceramic.

The flame-retardant ceramic includes aluminum hydroxide, boehmite, pseudoboehmite, magnesium hydroxide, or a combination thereof.

A mixing ratio of the plate-shaped polymer and the flame-retardant ceramic may be about 9:1 to about 7:3 by weight.

Embodiments include an all-solid-state battery. The all-solid-state battery includes a positive electrode; a negative electrode; a solid electrolyte layer between the positive electrode and the negative electrode; an elastic sheet for an all-solid-state battery, the elastic sheet including a plate-shaped polymer with an aspect ratio of about 1 to about 5 and a thickness of about 0.2 μm to about 4 μm; and a binder, wherein the elastic sheet is positioned on an outside of at least one of the positive electrode and the negative electrode.

The aspect ratio of the elastic sheet may be about 1.1 to about 4.5.

The thickness of the elastic sheet may be about 0.3 μm to about 2.5 μm.

The all plate-shaped polymer of the elastic sheet may include polyethylene particles.

The plate-shaped polymer of the elastic sheet may have a size of about 1 μm to about 8 μm.

An amount of the plate-shaped polymer may be about 10 wt % to about 70 wt %, based on a total weight of the elastic sheet.

The elastic sheet may further include a flame-retardant ceramic.

The flame-retardant ceramic may include aluminum hydroxide, boehmite, pseudoboehmite, magnesium hydroxide, or a combination thereof.

A mixing ratio of the plate-shaped polymer and the flame-retardant ceramic may be about 9:1 to about 7:3 by weight.

### BRIEF DESCRIPTION OF THE DRAWINGS

Features will become apparent to those of skill in the art by describing in detail exemplary embodiments with reference to the attached drawings in which:

FIG. 1 is a schematic diagram schematically showing an all-solid-state battery according to one or more embodiments.

FIG. 2 is a cross-sectional view schematically showing an all-solid-state battery according to another embodiment.

### DETAILED DESCRIPTION

An all-solid-state battery as disclosed may be structurally strong because the electrolyte is solid, and thus, there is a low risk of fire or explosion caused the electrolyte leakage due to external impact, or the like. In embodiments, an all-solid-state battery may be formed in various shapes.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that if a layer or element is referred to as being “on” another layer or substrate, it can be directly on the other layer or substrate, or intervening layers may also be present. Further, it will be understood that if a layer is referred to as being “under” another layer, it can be directly under, and one or more intervening layers may also be present. It will also be understood that if a layer is referred to as being “between” two layers, it can be the only layer between the two layers, or one or more intervening layers may also be present. Like reference numerals refer to like elements throughout.

Hereinafter, embodiments of the present disclosure are described in detail. However, these embodiments are merely examples and the scope of the claims is not limited thereto. The present invention is defined by the scope of the claims.

Terms used in the specification is used to explain embodiments, but are not intended limit the scope of the claims. Expressions in the singular include expressions in plural unless the context clearly dictates otherwise.

The term “combination thereof may include a mixture, a laminate, a complex, a copolymer, an alloy, a blend, a reactant of constituents.

The terms “comprise,” “include” and “have” are intended to designate that the performed characteristics, numbers, step, constituted elements, or a combination thereof is present, but it should be understood that the possibility of presence or addition of one or more other characteristics, numbers, steps, constituted element, or a combination are not to be precluded in advance.

In the specification, unless explicitly described to the contrary, the word “comprise” and variations such as “comprises” or “comprising” will be understood to imply the inclusion of stated elements but not the exclusion of any other element.

The terms “about” and “substantially” used throughout the present specification refer to the meaning of the mentioned with inherent preparation and material permissible errors if presented, and are used in the sense of being close to or near that value. They are used to help understand the various embodiments and to prevent exploiting the disclosure where accurate or absolute values are mentioned.

In the specification, “A and/or B” indicates “A or B or both of them”.

Unless otherwise defined in the specification, it will be understood that if an element, such as a layer, a film, a region, a plate, and the like is referred to as being “on” or “over” another element, it may be directly on, connected to, or coupled to the other element or layer, or one or more intervening elements may be present. It will also be understood that if an element is referred to as being “between” two elements, it may be the only element between the two elements, or one or more intervening elements may also be present.

In the present disclosure, “particle size” or “a particle diameter”, may be an average particle diameter. Unless otherwise defined in the specification, the average particle diameter may be defined as an average particle diameter D50 indicating the diameter of particles having a cumulative volume of 50 volume % in the particle size distribution. The particle size may be measured by a method well known to those skilled in the art, in an example embodiment, by a particle size analyzer, or by a transmission electron microscopic image, a scanning electron microscopic image), or a field emission scanning electron microscopy (FE-SEM). In another embodiments, a dynamic light-scattering measurement device is used to perform a data analysis, and the number of particles is counted for each particle size range, and from this, the average particle diameter (D50) value may be easily obtained through a calculation, or a laser diffraction method. The laser diffraction may be obtained by distributing particles to be measured in a distribution solvent and introducing it to a commercially available laser diffraction particle measuring device (e.g., MT 3000 available from Microtrac, Ltd.), irradiating ultrasonic waves of about 28 kHz at a power of 60 W, and calculating an average particle diameter (D50) in the 50% standard of particle distribution in the measuring device.

The term “thickness” may be measured through a photograph taken with an optical microscope, in an example embodiment, a scanning electron microscope.

One or more embodiments relate to an elastic sheet for an all-solid-state battery. Such an elastic sheet may be referred to as a buffer layer or an elasticity layer. The elastic sheet may uniformly transfer pressure to an electrode assembly including the negative electrode, a solid electrolyte, and a positive electrode, thereby appropriately contacts with the solid components and also reduce stress transmitted to the solid electrolyte, or the like. The elastic sheet may also buffer changes in the thickness of the electrode during charging and discharging.

An elastic sheet of an all solid-sate battery according to one or more embodiments may include a plate-shaped polymer with an aspect ratio of about 1 to about 5 and a thickness of about 0.2 μm to about 4 μm, and a binder.

In one or more embodiments, the aspect ratio may be a ratio of the length of the longest side to the length of the shortest side, in an example embodiment, the length of the longest side/length of the shortest side, of the three sides of the horizontal length, vertical length, and thickness which consists of the plate-shaped particle. The size of the plate-shaped particle indicates a length of the largest side of three sides of the horizontal length, vertical length, and thickness.

The horizontal length, the vertical length, and the thickness may be obtained by averaging value of the lengths measured after randomly selecting 100 particles through a scanning electron microscope (SEM).

An aspect ratio of the plate-shaped polymer may be, e.g., about 1 to about 5, about 1.1 to about 4.5, about 1.1 to about 3.0, or about 1.2 to about 2.0.

A thickness of the plate-shaped polymer may be, e.g., about 0.2 μm to about 4 μm, about 0.3 μm to about 2.5 μm, about 0.3 μm to about 2.0 μm, or about 0.4 μm to about 1.0 μm.

The plate-shaped polymer having the aspect ratio and the thickness may be used in the elastic sheet, which may help greatly improve safety in the event of the external shock to the all-solid-state battery, which external shock could cause penetration or cracking so that the internal short circuit could occur. In an implementation, if a nail were to penetrate the all-solid-state battery, the plate-shaped polymer may be adhered to the surface of the nail, thereby suppressing the internal short-circuit.

Outside of the above described ranges for the aspect ratio or the thickness of the plate-shaped polymer, the effect for improving safety in the event of the short-circuit could be insignificant.

The use of such a polymer in the elastic sheet may facilitate uniformly applying pressure to the electrode assembly.

A plate-shaped polymer could be included in the elastic sheet, the elastic sheet may be included in the electrode such as the positive electrode or the negative electrode, and the movement of ions and electrons in the electrodes could be interrupted to increase electrode resistance, which may not be appropriate. An elastic sheet could be used in the electrodes where the charge and discharge reaction occurs, rather than as an elastic sheet, could be mixed with an active material, or could be used in a coating layer on the active material layer, and the electrode resistance could be increased, which may not be appropriate.

The plate-shaped polymer may include polyethylene particles.

Generally, polyethylene may be classified into HDPE (High density polyethylene, density: 0.94 g/cc to 0.965 g/cc), MDPE (Medium density polyethylene, density: 0.925 g/cc to 0.94 g/cc), LDPE (Low density polyethylene, density: 0.91 g/cc to 0.925 g/cc), VLDPE (Very low density polyethylene, density: 0.85 g/cc to 0.91 g/cc), or the like, depending on the viscosity.

The plate-shaped polyethylene particle according to one or more embodiments may be one or two or more of polyethylene polymer such as HDPE, MDPE, or LDPE.

In one or more embodiments, the plate-shaped polymer may have a size of, e.g., about 1 μm to about 8 μm, or about 2 μm to about 6 μm. The size of the plate-shaped polymer may indicate as a size defined by D50. In an example embodiment, regardless of the shape of the plate-shaped polymer, a size may be measured using a D50 measurement.

In the elastic sheet according to one or more embodiments, an amount of the plate-shaped polymer may be, e.g., about 10 wt % to about 70 wt %, about 20 wt % to about 60 wt %, or about 30 wt % to about 50 wt % based on the total weight of the elastic sheet. In an implementation, the amount of the plate-shaped polymer may be included in the ranges, and the internal short-circuiting may be effectively suppressed, thus demonstrating allowing more improved safety during external shocking and allowing more uniform pressure to be applied to the electrode assembly.

The elastic sheet according to one or more embodiments may further include a flame-retardant ceramic. In an implementation, the elastic sheet may further include the flame-retardant ceramic, and the thermal safety may be improved. The flame-retardant ceramic may include, e.g., aluminum hydroxide, boehmite, pseudoboehmite, magnesium hydroxide, or a combination thereof.

In an implementation, the elastic sheet may further include the flame-retardant ceramic, and a sum amounts of the plate-shaped polymer and the flame-retardant ceramic may be, e.g., about 15 wt % to about 85 wt %, about 25 wt % to about 75 wt %, or about 35 wt % to about 65 wt %, based on the total weight of the elastic sheet.

In the elastic sheet, a mixing ratio of the plate-shaped polymer and the flame-retardant ceramic may be about 9:1 to about 6:4 by weight, or about 8:2 weight ratio to about 7:3 by weight. In an implementation, the mixing ratio of the plate-shaped polymer and the flame-retardant ceramic may be within the ranges, and the safety function due to the plate-shaped polymer and ceramic may be imparted to the elastic sheet, as well as the polymer and the ceramic may be uniformly distributed in the elastic sheet.

In one or more embodiments, the binder may effectively agglomerate the plate-shaped polymer particles to each other, and may be a material with elasticity, so that suitable materials may be used, as long as it has this function. In an example embodiment, the binder may include, e.g., polyurethane, a fluorine polymer, acrylate resin, natural rubber, spandex, a butyl rubber (Isobutylene Isoprene Rubber, IIR), an ethylene-propylene rubber (EPR), a styrene-butadiene rubber (SBR), chloroprene, elastine, rubber epichlorohydrin, nylon, terpene, isoprene rubber, polybutadiene, nitrile rubber, thermoplastic elastomer, silicon (e.g., silicone), ethylene-propylene-diene rubber (EPDM), ethylenevinyl acetate (EVA), halogenated butyl rubber, neoprene, or a copolymer thereof.

The polyurethane, in embodiments, may take the form of a copolymer or a homopolymer with a urethane group. The silicon may also be referred to as a silicon rubber or a silicon resin and may, in embodiments, take the form of a copolymer or a homopolymer including silicon, and the fluorine polymer may, in embodiments, take the form of a copolymer or a homopolymer including fluorine.

The binder may include polyether polyol and the polyether polyol may have a functionality of about 2 to about 4 and a number average molecular weight of about 2000 g/mol or more, and about 4000 g/mol or less.

The binder may also include polyester polyol. The polyester polyol may be a condensation product in which low molecular polyol such as ethylene glycol, diethylene glycol, propyleneglycol, butanediol, hexanediol, glycerine, trimethylolpropane, trimethylolethane, pentaerythritol, diglycerine, sorbitol, sucrose, or the like, and one such as succinic acid, sebacic acid, maleic acid, fumaric acid, phthalic acid, isophthalic acid, anhydrous succinic acid, maleic anhydride, anhydrous phthalic acid, or the like may be condensed. The polyester polyol may be polyol which is a ring-opening condensed product of caprolactone or methylvalerolactone classified as lactone ester. The polycarbonate-based polyol may be prepared by dealcoholization of polyhydric alcohol such as ethylene glycol, diethylene glycol, propylene glycol, butanediol, pentanediol, hexanediol, or the like, and dialkyl carbonate, dialkylene carbonate, diphenyl carbonate, or the like. In an implementation, it may have a functionality of about 2 to about 3 and a number average molecular weight of about 500 or more and about 1,000 or less (or hydroxyl group of about 112 mgKOH/g or more and about 224 mgKOH/g or less).

In an example embodiment, the polyacrylate may be derived from C1 to C20 alkyl (meth)acrylate, hydroxy C1 to C20 alkyl (meth)acrylate, or a combination thereof.

In embodiments, the C1 to C20 indicates a carbon number of an alkyl group, in an example embodiment, C1 to C18, C1 to C15, C1 to C12, C1 to C10, C1 to C8, C1 to C5. The (meth)acrylate indicates acrylate or methacrylate.

The C1 to C20 alkyl (meth)acrylate may be, in an example embodiment, methyl(meth)acrylate, ethyl (meth)acrylate, propyl (meth)acrylate, butyl (meth)acrylate, 2-ethylhexyl (meth)acrylate, 2-ethylpentyl (meth)acrylate, 2-ethylhepthyl (meth)acrylate, 2-ethylnonyl (meth)acrylate, 2-propylhexyl (meth)acrylate, 2-propyloctyl (meth)acrylate, or a combination thereof.

The hydroxy C1 to C20 alkyl (meth)acrylate may be, in an example embodiment, 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, or a combination thereof.

In an example embodiment, the acrylate resin may be derived from C1 to C20 alkyl (meth)acrylate and hydroxy C1 to C20 alkyl (meth)acrylate, and the mixing ratio of C1 to C20 alkyl (meth)acrylate and hydroxy C1 to C20 alkyl (meth)acrylate may be about 20:80 to about 90:10 by weight ratio, in an example embodiment, about 30:70 to about 90:10, about 40:60 to about 90:10, about 50:50 to about 90:10, or about 60:40 to about 80:20 by weight ratio. In some embodiments, the acrylate resin may exhibit appropriate adhesiveness and may be advantageous for realizing excellent compressive strength, a stress relaxation ratio, and a recovery ratio.

The acrylate resin may further include another repeating unit derived from acrylic acid, alkoxy-included acrylate, or the like. The acrylate resin may have an average molecular weight of about 400,000 to about 2,000,000.

Based on the total weight of the elastic sheet, an amount of the binder may be, e.g., about 30 wt % to about 90 wt %, about 40 wt % to about 80 wt %, or about 50 wt % to about 70 wt %. In an implementation, the amount of the binder may be within the ranges, and it may be uniformly mixed or dispersed with the polymer particles. In an implementation, the elastic sheet may include the plate-shaped polymer and the flame-retardant ceramic, and an amount of the binder may be about 15 wt % to about 85 wt %, about 25 wt % to about 75 wt %, or about 35 wt % to about 65 wt %.

The elastic sheet according to one or more embodiments may further include suitable additives in addition to the components. In an example embodiment, the additive may include a cross-linking binder (e.g., silica, a polyisocyanate compound), a tackifier (terpene, phenol, or the like), or the like.

Each additive may be included in a suitable amount according to the purpose, and there is no need to limit it.

In one or more embodiments, the thickness of the elastic sheet may be about 50 μm to about 800 μm, in an example embodiment, about 50 μm to about 600 μm, about 50 μm to about 500 μm, or about 150 μm to about 500 μm. In an implementation, the thickness of the elastic sheet may be within the ranges, and the stress due to pressurization and the stress due to the volume change during charging and discharging may be sufficiently relaxed and excellent restoring force may be exhibited.

### All-Solid-State Battery

Other embodiments include an all-solid-state battery including the elastic sheet. The all-solid-state battery may include a positive electrode, a negative electrode, a solid electrolyte layer between the positive electrode and the negative electrode, and the elastic sheet positioned outside of at least one of the positive electrode and the negative electrode.

The elastic sheet may be positioned on the outermost layer of an electrode assembly or may be also positioned on the outermost layer and/or inside the assembly in the structure in which at least two electrode assemblies are stacked. Considering that the thickness of the negative electrode is significantly changed due to a formation of dendrite, or the like during charge and discharge, the elastic sheet may be positioned on the outside of the negative electrode, in an example embodiment, on the opposite side of the surface where the solid electrolyte layer is in contact with the negative electrode, thereby serving as a buffer for solving the shortcomings due to the thickness changes. The elastic sheet may prevent the deterioration caused by the reaction with lithium by being positioned on the outside of the positive electrode and/or the negative electrode, so that the coulombic efficiency may be enhanced.

### Negative Electrode

The negative electrode may include a current collector and a negative electrode layer on one side of the current collector.

The negative electrode layer may be a negative active material layer, or a negative electrode coating layer. In some embodiments, the negative electrode layer may be a lithium metal layer.

In one or more embodiments, the term “the negative electrode coating layer” may refer to a layer that helps the movement of lithium ions released from the positive active material to the negative electrode during charging and discharging of the all-solid-state battery, thereby facilitating their deposition on the surface of the current collector. In an example embodiment, a lithium-containing layer, in an example embodiment, a lithium deposition layer, due to the deposition of lithium ions between the current collector and the negative electrode coating layer may be formed, and the lithium deposition layer may act as a negative active material. This negative electrode may take the form of a deposition-type negative electrode. The metal and amorphous carbon included in the negative electrode coating layer does not act as a negative active material which directly participates in the charge and discharge reaction. Such a deposition-type negative electrode represents a negative electrode that does not include a negative active material during the battery preparation, but the lithium-included layer acts as a negative active material.

The lithium-containing layer may be formed between the negative electrode current collector and the negative electrode coating layer.

The negative electrode coating layer may include a metal, a carbon-based material, or combination thereof which serve as a catalyst. In the negative electrode coating layer, in an example embodiment, a metal may be supported on a carbonaceous material, or a metal and a carbonaceous material may be mixed together. In one or more embodiments, the negative electrode coating layer may include the metal and the carbon-based material.

The carbonaceous material, may be, in an example embodiment, crystalline carbon, amorphous carbon, or a combination thereof. The crystalline carbon may be, in an example embodiment, natural graphite, artificial graphite, mesophase carbon microbead, carbon nanotube, graphene, or a combination thereof. The crystalline carbon may have unspecified shape, sheet shape, flake shape, spherical shape, or fiber shape. The amorphous carbon may be, in an example embodiment, carbon black, acetylene black, denka black, ketjen black, furnace black, activated carbon, graphene, or combinations thereof. A commercially available carbon black may be SUPER P®, available from Imerys Graphite & Carbon Switzerland SA (Bodio, Switzerland). In an implementation, a suitable material which may be classified as amorphous carbon may be used.

In one or more embodiments, the carbon material may include single particles, a secondary particle in which a plurality of primary particles is agglomerated, or combinations thereof. In an implementation, the carbon material may include only single particles, and the size of the carbon-based material may have an average particle diameter of about 100 nm or less, in an example embodiment, a nanosize of about 10 nm to about 100 nm.

In an implementation, the carbon material may include only an agglomerated product, and the particle diameter of the primary particle may be about 20 nm to about 100 nm and the particle diameter of the secondary particle may be about 1 μm to about 20 μm.

In one or more embodiments, a particle diameter of the primary particles may be about 20 nm to about 100 nm, about 20 nm to about 90 nm, about 20 nm to about 80 nm, or about 30 nm to about 70 nm.

In one or more embodiments, a particle diameter of the secondary particle may be about 1 μm to about 20 μm, about 2 μm to about 15 μm, or about 3 μm to about 10 μm.

The shape of the primary particle may be spherical, oval, plate-shaped, or combinations thereof, and in some embodiments, the shape of the primary particle may be spherical, oval, or combinations thereof.

The metal may be Ag, Au, Sn, Zn, Al, Mg, Ge, Cu, In, Ni, Bi, Pt, Pd, or a combination thereof. The inclusion of the metal in the negative electrode coating layer may further improve the electrical conductivity of the negative electrode.

The metal may be nano particles and the size of the metal nano particles, in an example embodiment, an average size, may be about 5 nm to about 800 nm, about 5 nm to about 700 nm, about 5 nm to about 500 nm, or about 5 nm to about 300 nm. In an implementation, the metal nanoparticles with nano size may be used, and the battery characteristics, e.g., cycle-life characteristics of the all-solid-state battery, may be improved. If the size of the metal particles were to increase to a micrometer unit, the uniformity of the metal particles could be reduced in the negative electrode coating layer, and thus, a current density could be increased at a specific region, thereby deteriorating the cycle-life characteristics.

In one or more embodiments, an amount of the metal may be about 3 wt % to about 30 wt %, about 4 wt % to about 25 wt %, about 5 wt % to about 20 wt %, or about 5 wt % to about 15 wt % based on the total weight of the metal and the carbon-based material.

The amount of the carbon material may be about 70 wt % to about 97 wt %, about 75 wt % to about 96 wt %, about 80 wt % to about 95 wt %, or about 85 wt % to about 95 wt % based on the total weight of the metal and the carbon material.

The negative electrode coating layer may further include a binder. The binder may be a non-aqueous-based binder.

The aqueous binder may include polyvinyl chloride, carboxylated polyvinyl chloride, polyvinyl fluoride, polyethylene oxide, an ethylene propylene copolymer, polystyrene, polyvinyl pyrrolidone, polyurethane, polytetrafluoroethylene, polyvinylidene fluoride, polyethylene, polypropylene, polyamide imide, polyimides, polyacrylate, or a combination thereof.

An amount of the binder may be about 1 wt % to about 15 wt % based on the total weight of the negative electrode coating layer. In an example embodiment, an amount of the binder may be about 1 wt % to about 14 wt %, about 1 wt % to about 12 wt %, about 1 wt % to about 10 wt %, about 2 wt % to about 8, or about 2 wt % to about 7 wt % based on the total weight of the negative electrode coating layer. In an implementation, the negative electrode coating layer may further include a binder, and an amount except for the binder in the total weight of the negative electrode coating layer may be the total amount of the carbon material and the metal and the ratio of the carbon material and the metal may be as described above. In an example embodiment, the total amount of the carbon material and the metal may be about 86 wt % to about 99 wt %, about 88 wt % to about 99 wt %, about 90 wt % to about 99 wt %, about 92 wt % to about 98 wt %, or about 93 wt % to about 98 wt %, and the ratio of the carbon material and the metal may be the above-described weight ratio of about 70:30 to about 97:3, about 75:25 to about 96:4, about 80:20 to about 95:5, or about 85:15 to about 95:5 by weight ratio.

In an implementation, the binder may be included in the negative electrode coating layer of the all-solid-state battery at the above weight ranges, and the electrical resistance and the adherence may be improved, thereby enhancing the battery characteristics, in an example embodiment, cycle-life characteristics of the all-solid-state battery.

The negative electrode coating layer may further include a solid electrolyte, and the solid electrolyte may be an inorganic solid electrolyte such as a sulfide solid electrolyte, an oxide solid electrolyte, a halide solid electrolyte, or the like, or a solid polymer electrolyte. In an implementation, the negative electrode coating layer may further include the solid electrolyte, in one or more embodiments, and an amount of the solid electrolyte may be about 1 parts by weight to about 30 parts by weight, about 5 parts by weight to about 25 parts by weight, or about 10 parts by weight to about 20 parts by weight based on the total 100 parts by weight of the negative electrode coating layer. In an implementation, the negative electrode coating layer may further include the solid electrolyte, and an amount of the carbon-based material and the metal may be appropriately adjusted, while maintaining the weight ratio within the above-described weight ratio of about 70:30 to 97:3, 75:25 to 96:4, 80:20 to 95:5, 85:15 to 95:5.

In one or more embodiments, the sulfide solid electrolyte may be Li₂S—P₂S₅, Li₂S—P₂S₅—LiX (where X is an halogen element, in an example embodiment, I, or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each an integer of about 0 or more and about 12 or less, Z is Ge, Zn, or Ga), Li₂S—GeS₂, Li₂S—SiS₂—Li₃PO₄, Li₂S—SiS₂—LiₚMO_{q} (where p and q are each an integer of about 0 or more and about 12 or less, and M is P, Si, Ge, B, Al, Ga, or In), LiₐM_{b}P_{c}S_{d}Aₑ (where a, b, c, d, and e may each be an integer of about 0 or more and about 12 or less, M is Ge, Sn, Si, or a combination thereof, and A is F, Cl, Br, or I). The sulfide-based solid electrolyte may be, in an example embodiment, Li₇₋ₓPS₆₋ₓFₓ (0≤x≤2), Li₇₋ₓPS₆₋ₓClₓ (0≤x≤2), Li₇₋ₓPS₆₋ₓBrₓ (0≤x≤2) or Li₇₋ₓPS₆₋ₓIₓ (0≤x≤2). In some embodiments, it may be Li₃PS₄, Li₇P₃S₁₁, Li₇PS₆, Li₆PS₅Cl, Li₆PS₅Cl, Li₆PS₅I, Li₆PS₅Br, Li_{5.8}PS_{4.8}Cl_{1.2}, Li_{6.2}PS_{5.2}Br_{0.8}, or the like.

In one or more embodiments, the sulfide solid electrolyte may be an argyrodite-type sulfide solid electrolyte. The argyrodite-type sulfide solid electrolyte may be, in an example embodiment, LiₐM_{b}P_{c}S_{d}Aₑ ((where a, b, c, d, and e are each an integer of about 0 or more and about 12 or less, M is Ge, Sn, Si, or a combination thereof, and A is F, Cl, Br, or I).

In some embodiments, the sulfide solid electrolyte may include Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, Li₆PS₅I, Li_{5.75}PS_{4.75}Cl_{1.25}, (Li_{5.69}Cu_{0.06})PS_{4.75}Cl_{1.25}, (Li_{5.72}Cu_{0.03})PS_{4.75}Cl_{1.25}, (Li_{5.69}Cu_{0.06})P(S_{4.70}SO_{40.05})Cl_{1.25}, (Li_{5.69}Cu_{0.06})P(S_{4.60}SO_{40.15})Cl_{1.25}, (Li_{5.72}Cu_{0.03})P(S_{4.725}SO_{40.025})Cl_{1.25}, (Li_{5.72}Na_{0.03})P(S_{4.725}SO_{40.025})Cl_{1.25}, Li_{5.75}P(S_{4.725}SO_{40.025})Cl_{1.25}, or a combination thereof.

The sulfide solid electrolyte may be amorphous, crystalline, or a combination thereof. The sulfide solid electrolyte may be prepared, in an example embodiment, by mixing Li₂S and P₂S₅ at a mole ratio of about 50:50 to about 90:10, or about 50:50 to about 80:2. In these ranges of the mixing ratio, the sulfide solid electrolyte exhibiting excellent ionic conductivity may be prepared. As other components, SiS2, GeS2, B2S3, or the like may be further included, thereby further improving ionic conductivity.

The mixing procedure of the sulfur-included source for preparing the sulfide solid electrolyte may be performed, in some embodiments, using a mechanical milling or a solution method. The mechanical milling may be performed by adding starting raw material, a ball mill, or the like in a reactor and vigorously stirring to pulverize the starting raw material and to mix them together. The solution method may provide a solid electrolyte as a precipitate by mixing starting raw material in a solvent. In an implementation, a heat treatment may be performed after mixing, the crystal of the solid electrolyte may be further solidified and ionic conductivity may be further improved. In an example embodiment, the sulfide solid electrolyte may be prepared by mixing sulfur-included raw materials and heat-treating them twice or more, which may provide a sulfide solid electrolyte with high ionic conductivity and rigidity.

The sulfide solid electrolyte may be a commercial solid electrolyte.

The oxide inorganic solid electrolyte may be, in an example embodiment, Li₁₊ₓTi₂₋ₓAl(PO₄)₃(LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃(PZT), Pb₁₋ₓLaₓZr_{1-y}Ti_{y}O₃(PLZT) (0 x<1, 0≤y<1), Pb(Mg₃Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃ (0<x<2, 0<y<3), Li_{1+x+y}(Al,Ga)ₓ(Ti,Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, Garnet-based ceramics Li₃₊ₓLa₃M₂O₁₂ (M=Te, Nb, or Zr, x is an integer of about 1 to about 10), or mixture thereof.

The solid polymer electrolyte may be at least one of, in an example embodiment, polyethylene oxide, poly(diallyldimethyl ammonium)trifluoromethane sulfonylimideTFSI), Cu₃N, Li₃N, LiPON, Li₃PO₄·Li₂S·SiS₂, Li₂S·GeS₂·Ga₂S₃, Li₂O·11Al₂O₃, Na₂O·11Al₂O₃, (Na,Li)₁₊ₓTi₂₋ₓAlₓPO₄₃ (0.1≤x≤0.9), Li₁₊ₓHf₂₋ₓAlₓ(PO₄)₃ (0.1≤x≤0.9), Na₃Zr₂Si₂PO₁₂, Li₃Zr₂Si₂PO₁₂, Na₅ZrP₃O₁₂, Na₅TiP₃O₁₂, Na₃Fe₂P₃O₁₂, Na₄NbP₃O₁₂, Na-Silicates, Li_{0.3}La_{0.5}TiO₃, Na₅MSi₄O₁₂ (M is a rare earth element such as Nd, Gd, Dy, or the like), Li₅ZrP₃O₁₂, Li₅TiP₃O₁₂, Li₃Fe₂P₃O₁₂, Li₄NbP₃O₁₂, Li₁₊ₓ(M,Al,Ga)ₓ(Ge_{1-y}Ti_{y})₂₋ₓPO₄₃ (0≤x≤0.8, 0≤y≤1.0, M is Nd, Sm, Eu, Gd, Tb, Dy, Ho, Er, Tm or Yb), Li_{1+x+y}QₓTi₂₋ₓSi_{y}P_{3-y}O₁₂ (0<x≤0.4, 0<y≤0.6, Q is Al or Ga), Li₆BaLa₂Ta₂O₁₂, Li₇La₃Zr₂O₁₂, Li₅La₃Nb₂O₁₂, Li₅La₃M₂O₁₂ (M is Nb, Ta) or Li₇₊ₓAₓLa₃₋ₓZr₂O₁₂ (0<x<3, A is Zn).

The halide solid electrolyte may include a Li element, an M element (where M is a metal except for Li), and a X element (where X is a halogen). The X may be, in an example embodiment, F, Cl, Br and I. In some embodiments, the halide-based solid electrolyte may include at least one of Br and Cl, as the X. The M may be, in an example embodiment, a metal element such as Sc, Y, B, Al, Ga, In, and the like.

In an implementation, the halide solid electrolyte may be represented by Li6-3aMaBrbClc (where, M is a metal, except for Li, 0<a<2, 0≤b≤6, 0≤c≤6, b+c=6). The a may be about 0.75 or more, or about 1 or more, and the a may be about 1.5 or less. The b may be about 1 or more, or about 2 or more. The c may be about 3 or more, or about 4 or more. In one or more embodiments, the halide solid electrolyte may be Li₃YBr₆, Li₃YCl₆ or Li₃YBr₂Cl₄.

The negative catalyst layer may further include, in an example embodiment, additives such as a filler, a dispersing agent, an ionic conductive material, or the like. As the filler, the dispersing agent, the ionic conductive material included in the negative catalyst layer, a well-known material generally used for the all-solid-state battery may be used.

A thickness of the negative electrode coating layer may be, in an example embodiment, about 1 μm to about 500 μm, about 1 μm to about 200 μm, about 1 μm to about 100 μm, or about 1 μm to about 50 μm.

The current collector may include, in an example embodiment, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may have a foil shape or a sheet shape. A thickness of the current collector may be about 1 μm to 20 μm, about 5 μm to about 15 μm, or about 7 μm to about 10 μm.

The current collector may include the metal as a substrate and may further include a thin membrane on the substrate. The thin membrane may include an element being capable of forming an alloy with lithium, in an example embodiment, gold, silver, zinc, tin, indium, silicon, aluminum, bismuth, or a combination thereof, and may include suitable elements forming an alloy with lithium. In an implementation, the current collector may further include a thin membrane, and the more flattened lithium-containing layer may be formed, if the lithium is deposited during charging to form the lithium-containing layer, thereby further improving the cycle-life characteristics of the all-solid-state battery.

A thickness of the thin membrane may be about 1 nm to about 800 nm, about 10 nm to about 700 nm, about 50 nm to about 600 nm, or about 100 nm to about 500 nm. In an implementation, the thickness of the thin membrane may be within the ranges, and the cycle-life characteristics may be further enhanced.

The negative electrode according to one or more embodiments may further include a lithium-containing layer between the current collector and the negative electrode coating layer at the initial charge after the battery preparation. In an example embodiment, the thickness of the lithium-containing layer may be about 1 μm to about 1000 μm, about 1 μm to about 500 μm, about 1 μm to about 200 μm, about 1 μm to about 150 μm, about 1 μm to about 100 μm, or about 1 μm to about 50 μm. In an implementation, the thickness of the lithium-containing layer may be within the ranges, and it may effectively perform the role of a lithium reservoir and the cycle-life characteristics may be further enhanced.

The lithium-containing layer may be formed by releasing lithium ions from a positive active material, passing through the solid electrolyte and moving to the negative electrode, and thus, it is precipitated and deposited on the negative current collector, after fabricating the battery.

The charging may be a formation process which may be performed at 0.05 C to 1 C at about 25° C. to about 50° C. once to three times. If lithium is precipitated and deposited to form the lithium-containing layer, lithium included in the lithium-containing layer is ionized during discharging to move to the positive direction, and thus, this lithium may be used as a negative active material.

In one or more embodiments, as the lithium-containing layer is positioned between the current collector and the negative electrode coating layer, the negative electrode coating layer may serve as a protective layer for the lithium-containing layer, and thus, the deposition growth of lithium dendrite may be suppressed. This enables to inhibit capacity fading and short-circuit of the all-solid-state battery and resultantly improve the cycle-life of the all-solid-state battery.

The negative active material layer includes a negative active material and may include a binder, optionally may further include a conductive material.

The negative active material may include a material capable of reversibly intercalating/deintercalating lithium-ion, a lithium metal, an alloy of lithium metal, a material capable of doping and dedoping lithium, or a transition metal oxide.

The material capable of reversibly intercalating/deintercalating the lithium-ion may be a carbon-based negative active material, and in an example embodiment, may be crystalline carbon, amorphous carbon, or a combination thereof. The crystalline carbon may be graphite such as unspecified shape, sheet, flake, spherical or fiber shaped natural graphite or artificial graphite, and the amorphous carbon may be soft carbon, hard carbon, mesophase pitch carbide, sintered cokes, and the like.

Lithium, and a metal alloy, in some embodiments, may be selected from Na, K, Rb, Cs, Fr, Be, Mg, Ca, Sr, Si, Sb, Pb, In, Zn, Ba, Ra, Ge, Al, and Sn, and may be used as the alloy of the lithium metal.

Examples of the material capable of doping and dedoping lithium may include a Si-based negative active material or a Sn-based active material, and the Si-based negative active material may be Si, Si—C composite, SiOx (0<x<2), Si-Q alloys (where Q is selected from alkali metals, alkali-earth metals, group 13 elements, group 14 elements, group 15 elements, group 16 elements, transition metals, rare earth elements, and combination thereof, but Q is not Si), and the Sn-based negative active material may be Sn, SnO2, and Sn—R (where R is selected from alkali metal, alkaline earth metals, group 13 elements, group 14 elements, group 15 elements, group 16 elements, transition metals, rare earth elements, and combinations thereof, but R is not Sn), or the like. At least one of these materials may be mixed with SiO₂. The elements Q and R may be independently selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and combinations thereof.

The silicon-carbon composite may be, in an example embodiment, a silicon-carbon composite including a core having crystalline carbon and silicon particles and an amorphous carbon coating layer on the surface of the core. The crystalline carbon may be artificial graphite, natural graphite, or a combination thereof. The amorphous carbon may be soft carbon, hard carbon, mesophase pitch carbide, sintered cokes, and the like. An amount of silicon may be about 10 wt % to about 50 wt % based on the total weight of the silicon-carbon composite. An amount of the crystalline carbon may be about 10 wt % to about 70 wt % based on the total weight of the silicon-carbon composite and an amount of the amorphous carbon may be about 20 wt % to about 40 wt % based on the total weight of the silicon-carbon composite. A thickness of the amorphous carbon coating layer may be about 5 nm to about 100 nm.

An average particle diameter (D₅₀) of the silicon particle may be about 10 nm to about 20 μm, or about 10 nm to about 500 nm. The silicon particle may be presented in an oxidized form and an atomic weight ratio of Si:O representing a degree of oxidation may be about 99:1 to about 33:67. The silicon particle may be SiOₓ particles and in SiOₓ, a range for x may be more than about 0 and less than about 2. As used herein, an average particle diameter D50 indicates a diameter of particle where the cumulative volume corresponds to about 50 volume % in the particle size distribution, as measured by, in embodiments, a particle size analyzer using a laser diffraction method.

The Si-based negative active material or the Sn-based negative active material may be mixed with the carbon-based negative active material to use. A mixing ratio of the Si-based negative active material or the Sn-based negative active material, and the carbon-based negative active material may be a weight ratio of about 1:99 to about 90:10.

In the negative active material layer, an amount of the negative active material may be about 95 wt % to about 99 wt % based on the total weight of the negative active material layer.

In the negative active material layer, an amount of the binder may be about 1 wt % to about 5 wt % based on the total weight of the negative active material layer. In case of further including the conductive material, the negative active material may be included at an amount of about 90 wt % to about 98 wt %, the binder may be included at an amount of about 1 wt % to about 5 wt %, and the conductive material may be included at an amount of about 1 wt % to about 5 wt %.

The binder improves binding properties of negative active material particles with one another and with a current collector. The binder may be a non-aqueous-based binder, an aqueous-based binder, or combination thereof.

The non-aqueous binder may be polyvinylchloride, carboxylated polyvinylchloride, polyvinyl fluoride, polyethylene oxide, an ethylene propylene copolymer, polystyrene, polyvinylpyrrolidone, polyurethane, polytetrafluoroethylene, polyvinylidene fluoride, polyethylene, polypropylene, polyamideimide, polyimide, or a combination thereof.

The aqueous binder may be a styrene-butadiene rubber, an acrylated styrene-butadiene rubber, an acrylonitrile-butadiene rubber, an acrylic rubber, a butyl rubber, a fluorine rubber, polyvinyl pyrrolidone, polyepichlorohydrin, polyphosphazene, polyacrylonitrile, an ethylene propylenediene copolymer, polyvinyl pyridine, chlorosulfonated polyethylene, latex, a polyester resin, an acrylic resin, a phenolic resin, an epoxy resin, polyvinyl alcohol, or combinations thereof.

As the negative electrode binder, a cellulose-based compound may be used. The cellulose-based compound and the aqueous binder may be used together therewith. The cellulose-based compound includes one or more of carboxymethyl cellulose, hydroxypropylmethyl cellulose, methyl cellulose, or alkali metal salts thereof. The alkali metal may be Na, K, or Li. The cellulose-based compound may serve as a binder and serve as a thickener to impart viscosity. An amount of the cellulose-based compound may be, e.g., about 0.1 parts by weight to about 3 parts by weight based on 100 parts by weight of the negative active material.

A suitable binder may be used and the amount thereof may be appropriately adjusted.

The conductive material is included to provide electrode conductivity. Examples of the conductive material may include a carbon-based material such as natural graphite, artificial graphite, carbon black, acetylene black, ketjen black, carbon fiber, carbon nanotube, and the like; a metal-based material of a metal powder or a metal fiber including copper, nickel, aluminum, silver, and the like; a conductive polymer such as polyphenylene derivatives; or mixtures thereof.

The negative electrode current collector may include one selected from a copper foil, a nickel foil, a stainless steel foil, a titanium foil, a nickel foam, a copper foam, a polymer substrate coated with a conductive metal, and a combination thereof.

### Positive Electrode

The positive electrode may include a positive current collector and a positive active material layer on the positive current collector.

The positive active material layer may include a positive active material. The positive active material may include compounds that reversibly intercalate and deintercalate lithium ions. In an example embodiment, it may include one or more composite oxides of a metal selected from cobalt, manganese, nickel, and a combination thereof, and lithium. Non-limiting examples of the positive active material may include LiₐA_{1-b}B¹_{b}D¹₂ (0.90≤a≤1.8, 0≤b≤0.5); LiₐE_{1-b}B¹_{b}O_{2-c}D¹_{c} (0.90≤a≤1.8, 0≤b≤0.5, 0≤c≤0.5); LiₐE_{2-b}B¹_{b}O_{4-c}D¹_{c} (0.90≤a≤1.8, 0≤b≤0.5, 0≤c≤05); LiₐNi_{1-b-c}Co_{b}B¹_{c}D¹_{α} (0.90≤a≤1.8, 0≤b≤0.5, 0≤c≤0.5, 0<α≤2); LiₐNi_{1-b-c}Co_{b}B¹_{c}O_{2-α}F¹_{α} (0.90≤a≤1.8, 0≤b≤0.5, 0≤c≤0.5, 0<α<2); LiₐNi_{1-b-c}Co_{b}B¹_{c}O_{2-α}F¹₂ (0.90≤a≤1.8, 0≤b≤0.5, 0≤c≤0.5, 0<α<2); LiₐNi_{1-b-c}Mn_{b}B¹_{c}D¹_{α} (0.90≤a≤1.8, 0≤b≤0.5, 0≤c≤0.5, 0<α≤2); LiₐNi_{1-b-c}Mn_{b}B¹_{c}O_{2-α}F¹_{α} (0.90≤a≤1.8, 0≤b≤0.5, 0≤c≤0.5, 0<α<2); LiₐNi_{1-b-c}Mn_{b}B¹_{c}O_{2-α}F¹₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMnG_{b}O₂ (0.90≤a≤1.8, 0.001≤b≤0.1); LiₐMn₂G_{b}O₄ (0.90≤a≤1.8, 0.001≤b≤0.1); QO₂; QS₂; LiQS₂; V₂O₅; LiV₂O₅; LiI¹O₂; LiNiVO₄; Li_{(3-f)}J₂(PO₄)₃ (0≤f≤2); Li_{(3-f)}Fe₂(PO₄)₃ (0≤f≤2); or LiFePO₄.

In the chemical formulas, A may be selected from Ni, Co, Mn, or a combination thereof; B¹ may be selected from Al, Ni, Co, Mn, Cr, Fe, Mg, Sr, V, a rare earth element, or a combination thereof; D¹ may be selected from O, F, S, P, or a combination thereof; E may be selected from Co, Mn, or a combination thereof; F¹ may be selected from F, S, P, or a combination thereof; G may be selected from Al, Cr, Mn, Fe, Mg, La, Ce, Sr, V, or a combination thereof; Q may be selected from Ti, Mo, Mn, or a combination thereof; I¹ may be selected from Cr, V, Fe, Sc, Y, or a combination thereof; J may be selected from V, Cr, Mn, Co, Ni, Cu, or a combination thereof; and L¹ may be selected from Mn, Al, or a combination thereof.

According to some embodiments, the positive active material may be a three-component-based lithium transition metal oxide such as LiNixCoyAlzO2 (NCA), LiNixCoyMnzO2 (NCM) (wherein, 0<x<1, 0<y<1, 0<z<1, x+y+z=1), etc.

The compounds may have a coating layer on the surface or may be mixed with another compound having a coating layer. The coating layer may include at least one coating element compound selected from an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be provided by a method having no (or substantially no) adverse influence on properties of a positive active material by using these elements in the compound. In an example embodiment, the method may include any suitable coating method such as spray coating, dipping, and/or the like, but is not illustrated in more detail because it should be readily recognizable to those of ordinary skill in the art upon reviewing the present disclosure.

Furthermore, the coating layer may be any coating materials which are known as a coating layer for the positive active material of the all-solid-state battery. In an example embodiment, the coating layer may be a buffer layer which serves to reduce an interface resistance of the positive active material and the solid electrolyte. In an example embodiment, the buffer layer may include lithium-metal-oxide and this metal may be one or more elements selected from Al, B, Ca, Ce, Cr, Fe, Mg, Mo, Nb, Si, Sn, Sr, Ta, V, W, or Zr. The example of the buffer layer may be Li₂O—ZrO₂ (LZO), and the like.

If the positive active material is three-components including nickel, cobalt, and manganese, or nickel, cobalt, and aluminum, the capacity density of the all-solid-state battery may be further improved, the metal elution from the positive active material at charged state may be further reduced. This may render to further improve long reliability and cycle characteristics of the all-solid-state battery at charged state.

The average particle diameter of the positive active material may be about 1 μm to 25 μm, in an example embodiment, 3 μm to 25 μm, 1 μm to 20 μm, 1 μm to 18 μm, 3 μm to 15 μm, or 5 μm to 15 μm. In an example embodiment, the positive active material may include small particles with an average particle diameter D50 of about 1 μm to about 9 μm and large particles with an average particle diameter D50 of about 10 μm to about 25 μm. The positive active material with the particle diameter range may be harmoniously mixed with other components in the positive active material layer and may achieve high capacity and high energy density.

The positive active material may be a secondary particle where a plurality of primary particles is agglomerated, or monocrystalline (single crystal). The shape of the positive active material may be, a spherical shape, a shape close to spherical, or a particle shape such as polyhedron, or unspecified shape, or the like.

In the positive active material layer, an amount of the positive active material may be in a suitable range which may be applied to a positive electrode layer of a conventional all-solid-state secondary battery. In an example embodiment, based on the total 100 wt % of the positive active material layer, the positive active material may be included at about 55 wt % to about 99.5 wt %, in an example embodiment, about 65 wt % to about 95 wt %, or about 75 wt % to about 91 wt %.

The positive active material layer may further include a binder and/or a conductive material.

The binder may be polyvinyl alcohol, carboxymethyl cellulose, hydroxypropylcellulose, diacetylcellulose, polyvinylchloride, carboxylated polyvinylchloride, polyvinylfluoride, polyethylene oxide, polyvinylpyrrolidone, polyurethane, polytetrafluoroethylene, polyvinylidene fluoride, polyvinylidene fluoride-hexafluoropropylene, polyethylene, polypropylene, styrene-butadiene rubber, an acrylated styrene-butadiene rubber, epoxy resin, nylon, or the like.

The binder may be included in an amount of about 0.1 wt % to about 5 wt %, or about 0.1 wt % to about 3 wt % based on the total 100 wt % of the positive active material layer. If in the range of the amount of the binder, the adhesion ability may be sufficiently secured without deteriorating the battery performances.

The conductive material is included to provide electrode conductivity. Any electrically conductive material may be used as a conductive material unless it causes a chemical change. Examples of the conductive material may include a carbon-based material such as natural graphite, artificial graphite, carbon black, acetylene black, ketjen black, carbon fiber, carbon nanofiber, carbon nanotube and the like; a metal-based material of a metal powder or a metal fiber including; copper, nickel, aluminum, silver, and the like; material; a conductive polymer such as polyphenylene derivatives; or mixtures thereof.

The conductive material may be included in an amount of about 0.1 wt % to about 5 wt %, or about 0.1 wt % to about 3 wt % based on the total 100 wt % of the positive active material layer. The conductive material in the above amount range may improve the electrical conductivity without deteriorating battery performance.

The positive active material layer may further include a solid electrolyte. The solid electrolyte included in the positive active material layer may be an inorganic solid electrolyte such as a sulfide-based solid electrolyte, an oxide-based solid electrolyte, a halide-based solid electrolyte, and the like, or a solid polymer electrolyte. The solid electrolyte included in the positive electrode may be the same as or different from the solid electrolyte included in the negative electrode.

Based on the total weight of the positive active material layer, the solid electrolyte may be included at an amount of about 0.1 wt % about to 35 wt %, in an example embodiment, about 1 wt % to about 35 wt %, about 5 wt % to about 30 wt %, about 8 wt % to about 25 wt %, or about 10 wt % to about 20 wt %. In the positive active material layer, based on the total weight of the positive active material and the solid electrolyte, the positive active material of about 65 wt % to about 99 wt % and the solid electrolyte of about 1 wt % to about 35 wt % may be included. In an example embodiment, the positive active material of about 80 wt % to about 90 wt % and the solid electrolyte of about 10 wt % to about 20 wt % may be included. If the solid electrolyte with the amount of the above range is included in the positive electrode, the efficiency and cycle-life characteristic of the all-solid-state battery may be improved, without deterioration of capacity.

The positive current collector may be, in an example embodiment, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may have a foil shape or a sheet shape.

### Solid Electrolyte Layer

The solid electrolyte layer may include a solid electrolyte. The solid electrolyte may be an inorganic solid electrolyte such as a sulfide-based solid electrolyte, an oxide-based solid electrolyte, a halide-based solid electrolyte, and the like, or solid polymer electrolyte.

In one or more embodiments, an inorganic solid electrolyte may be the sulfide-based solid electrolyte, the sulfide-based solid electrolyte, the oxide-based solid electrolyte, the halide-based solid electrolyte, or the solid polymer electrolyte as described above.

The solid electrolyte may have a particle shape, and may have an average particle diameter D50 of about 5.0 μm or less, in an example embodiment, about 0.1 μm to 5.0 μm, about 0.5 μm to about 5.0 μm, about 0.5 μm to about 4.0 μm, about 0.5 μm to about 3.0 μm, about 0.5 μm to about 2.0 μm, or about 0.5 μm to about 1.0 μm.

The solid electrolyte layer may further include a binder. The binder may be a styrene butadiene rubber, polytetrafluoroethylene, polyvinylidene fluoride, polyethylene, acrylate-based polymer or a combination thereof, and may be any material which is generally used in the related art. The acrylate-based polymer may be butyl acrylate, polyacrylate, polymethacrylate, or a combination thereof.

The solid electrolyte layer may be prepared by adding a solid electrolyte to a binder solution, coating it on a substrate film, and drying it. The binder solution may include isobutylyl isobutylate, xylene, toluene, benzene, hexane, or a combination thereof, as a solvent. The solid electrolyte layer preparation is widely known in the art, so a detailed description thereof will be omitted in the specification.

The solid electrolyte layer may further include an alkali metal salt, and/or an ionic liquid, and/or a conductive polymer.

The alkali metal salt may be, in an example embodiment, a lithium salt. In the solid electrolyte layer, an amount of the lithium salt may be about 1 M or more, in an example embodiment, about 1 M to about 4 M. In this case, the lithium salt may improve the lithium-ion mobility of the solid electrolyte layer, thereby improving ionic conductivity.

The lithium salt, may be, in an example embodiment, LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato) borate (LiBOB), lithium oxalyldifluoroborate (LIODFB), lithium difluoro(oxalato)borate (LiDFOB), lithium bis(trifluoro methanesulfonyl)imide, LiTFSI, LiN(SO₂CF₃)₂), lithium bis(fluorosulfonyl)imide, LiFSI, LiN(SO₂F)₂), LiCF₃SO₃, LiAsF₆, LiSbF₆, LiClO₄, or a mixture thereof.

The lithium salt may be an imide-based, in an example embodiment, the imide-based lithium salt may be lithium bis(trifluoro methanesulfonyl)imide (LiTFSI, LiN(SO₂CF₃)₂), lithium bis(fluorosulfonyl)imide (LiFSI, or LiN(SO₂F)₂). The lithium salt may suitably maintain the chemical reactivity with the ionic liquid, and thus, the ionic conductivity may be maintained or improved.

The ionic liquid may have a melting point of room temperature or less which may be a liquid state at a room temperature and salts consisting of only ion, or a room-temperature molten salt.

The ionic liquid may be a compound including a) at least one cation selected from a) ammonium-based, pyrroleridinium-based, pyridinium-based, pyrrimidinuim-based, imidazolium-based, piperidinum-based, pyrazolium-based, oxazolium-based, pyridazium-based, phosphonium-based, sulfonium-based, triazolium-based, or mixture thereof, and b) at least one anion selected from BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, CF₃SO₃⁻, FSO₂₂N⁻, (C₂F₅SO₂)₂N⁻, (C₂F₅SO₂)(CF₃SO₂)N⁻, or (CF₃SO₂)₂N⁻.

The ionic liquid may be, in an example embodiment, at least one selected from N-methyl-N-propylpyrroledinium bis(trifluoromethanesulfonyl)imide N-butyl-N-methylpyrroleridinium bis(3-trifluoromethylsulfonyl)imide, 1-butyl-3-methylimidazoleium bis(trifluoromethylsulfonyl)amide, 1-ethyl-3-methylimidazoleium, and bis(trifluoromethylsulfonyl)amide.

In the solid electrolyte layer, the weight ratio of the solid electrolyte and the ionic liquid may be about 0.1:99.9 to about 90:10, in an example embodiment, about 10:90 to about 90:10, about 20:80 to about 90:10, about 30:70 to about 90:10, about 40:60 to about 90:10, or about 50:50 to about 90:10. The solid electrolyte layer within the noted range may have an improved electrochemical contact area to the electrode, and thus, the ionic conductivity may be maintained or improved. This may render to improve the energy density, discharge capacity, rate capability, or the like of the all-solid-state battery may be improved.

The all-solid-state battery may be a unit battery including a structure of the positive electrode/the solid electrolyte layer/the negative electrode, a bicell including a structure of the positive electrode/the solid electrolyte layer/the negative electrode/the solid electrolyte layer/the positive electrode, or a stacked battery where the unit batteries are repeated.

The shapes of the all-solid-state battery may be a coin-type, a button-type, a sheet-type, a laminate-type, a cylindrical-type, or a flat-type, or the like. The all-solid-state battery may be applied to medium-to-large batteries used in electric vehicles. In an example embodiment, the all-solid-state battery may also be used in hybrid vehicles such a plug-in hybrid electric vehicle (PHEV), or the like. The all-solid-state battery may be applied to technology areas where a large amount of power storage is required, in an example embodiment, it may also be applied to electric bicycles or power tools. Furthermore, the all-solid-state rechargeable battery may be used in various fields such as portable electronic devices.

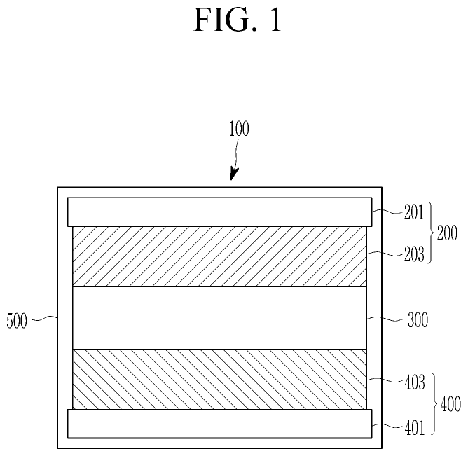

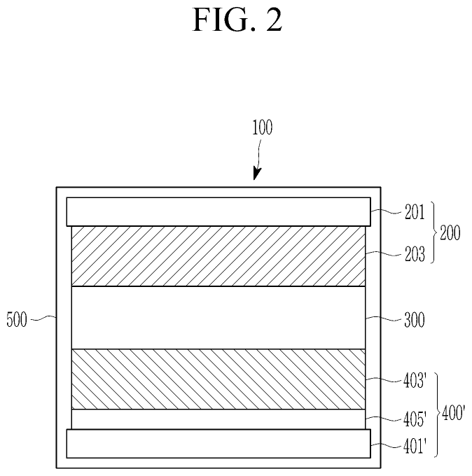

FIG. 1 is a cross-sectional view showing the all-solid-state battery according to embodiments. Referring to FIG. 1, the all-solid-state battery 100 may have a structure in which an electrode assembly is stacked with a negative electrode 400 including a negative current collector 401 and a negative coating layer 403, a solid electrolyte layer 300, a positive electrode 200 including a positive current collector 201 and a positive active material layer 203, may be housed in a case 500 such as a pouch, or the like. The all-solid-state battery may further include an elastic layer positioned on the outside of at least one of the positive electrode 200 and the negative electrode 400. FIG. 2 shows an electrode assembly including a negative electrode 400, a solid electrolyte layer 300, and a positive electrode 200, but it may be an all-solid-state battery fabricated by stacking at least two electrode assemblies.

FIG. 2 is a schematic cross-sectional view of the all-solid-state battery of one or more embodiments. The all-solid-state battery 100 shown in FIG. 2 includes a positive electrode 20 including a positive current collector 201 and a positive active material layer 203, a negative electrode 400 including a negative electrode current collector 401 and a negative electrode coating layer 403, a solid electrolyte 300 between the positive electrode 200 and the negative electrode 400, a battery case 500 in which these are housed, and a lithium deposition layer 405′ between the negative current collector 401 and the negative coating layer 403. Such a lithium deposition layer may be formed by releasing lithium ions from the positive electrode to deposit on the negative current collector 401′ during charging.

The all-solid-state battery according to one or more embodiments may be

fabricated by sequentially stacking the positive electrode, the negative electrode and the solid electrolyte between the positive electrode and the negative electrode to prepare an assembly and pressurizing the assembly.

The pressurization may be carried out at a temperature of about 25° C. to about 90° C. The pressurization may be carried out under a pressure of about 550 MPa, in an example embodiment, about 500 MPa or less, in an example embodiment, a pressure of about 1 MPa to about 500 MPa. The pressurization time may be varied depending on temperature and pressure, in an example embodiment, it may be less than about 30 minutes. The pressurization may be, in an example embodiment, isostatic press, warm isostatic press, roll press, or plate press.

Hereinafter, example embodiments and comparative examples are described. These examples, however, are not in any sense to be interpreted as limiting.

### Example 1

### (1) Preparation of Elastic Sheet

A 40 wt % of a plate-shaped polyethylene particle with an aspect ratio of 1.5, a thickness of 0.5 μm, and an average particle diameter D50 of 6 μm and 60 wt % of a polyether polyol binder (functionality: 3, number average molecular weight: 3000 g/mol), were mixed in a toluene solvent to prepare a composition for an elastic sheet.

The resulting mixture was coated on a polyethylene terephthalate (PET) film as a release film and was irradiated with ultraviolet (UV) with a light quantity of 2,000 mJ/cm² to prepare an elastic sheet adhered on the PET film.

### (2) Preparation of Negative Electrode

Carbon black with an average particle diameter D50 of approximately 30 nm and silver (Ag) with an average particle diameter D50 of approximately 60 nm were mixed at a weight ratio of 3:1, the mixture of 0.25 g was added to 2 g of an N-methyl pyrrolidone solution including 7 wt % of polyvinylidene fluoride binder, and then mixed to prepare a composition for a negative active material layer.

The composition for the negative active material layer was coated on a nickel foil current collector using a bar coater and vacuum-dried to prepare a negative electrode.

### (3) Preparation of Positive Electrode

85 wt % of a LiNi_{0.8}Co_{0.15}Mn_{0.05}O₂ positive active material, 13.5 wt % of a lithium argyrodite-type solid electrolyte Li₆PS₅Cl, 1.0 wt % of a polyvinylidene fluoride binder, and 0.5 wt % of a carbon nanotube conductive material were mixed in an N-methyl pyrrolidone solvent to prepare a positive electrode composition.

The prepared positive electrode composition was coated on an aluminum positive current collector using a bar coater and dried followed by pressurizing to prepare a positive electrode.

### (4) Preparation of Solid Electrolyte Layer

To an argyrodite-type solid electrolyte Li₆PS₅Cl, a binder solution in which butyl acrylate as an acrylate-based polymer was added to isobutylyl isobutylate binder solution (solid amount: 50 wt %) and then mixed. A mixing ratio of the solid electrolyte and the binder was a weight ratio of 98.7:1.3.

The mixing process was carried out using a THINKY mixer, which is a planetary centrifugal bubble-free mixer that mixes, disperses, and degasses viscous materials in minutes. The mixture was added with a 2 mm zirconia ball and was repeatedly agitated using a THINKY mixer to prepare a slurry. The slurry was casted on a release polytetrafluoroethylene film and dried at a room temperature to prepare a solid electrolyte layer with a thickness of 100 μm.

### (5) Fabrication of All-Solid-State Battery Cell

The prepared positive electrode, the solid electrolyte layer, and the negative electrode were sequentially stacked, and then the elastic sheet was stacked on the negative electrode. Thereafter, the negative electrode, the solid electrolyte layer and the positive electrode were sequentially stacked to prepare an assembly with an order of positive electrode/solid electrolyte/negative electrode/elastic sheet/negative electrode/solid electrolyte/positive electrode.

The assembly was inserted into a laminate film and isostatic pressurized under a 500 MPa at 80° C. to fabricate an all-solid-state battery cell.

In the pressurized state, the thickness of the positive active material layer was about 100 μm, the thickness of the negative active material layer was about 7 μm, the thickness of the solid electrolyte layer was about 60 μm, and the thickness of the elastic sheet was about 120 μm.

### Example 2

An all-solid-state cell was fabricated by the same procedure as in Example 1, except that 40 wt % of a plate-shaped polyethylene particle with an aspect ratio of 1.5, a thickness of 0.8 μm, and a size D50 of 6 μm and 60 wt % of a polyether polyol binder were mixed in a toluene solvent to prepare a composition for an elastic sheet.

### Example 3

An all-solid-state cell was fabricated by the same procedure as in Example 1, except that 40 wt % of a plate-shaped polyethylene particle with an aspect ratio of 1.8, a thickness of 0.5 μm, and a size D50 of 6 μm and 60 wt % of a polyether polyol binder were mixed in a toluene solvent to prepare a composition for an elastic sheet.

### Example 4

An all-solid-state battery cell was fabricated by the same procedure as in Example 1, except that 40 wt % of a plate-shaped polyethylene particle with an aspect ratio of 1.8, a thickness of 0.8 μm, and a size D50 of 6 μm and 60 wt % of a polyether polyol binder were mixed in a toluene solvent to prepare a composition for an elastic sheet.

### Example 5

An all-solid-state battery cell was fabricated by the same procedure as in Example 1, except that 30 wt % of a plate-shaped polyethylene particle with an aspect ratio of 1.5, a thickness of 0.5 μm, and a size D50 of 6 μm, 10 wt % of a pseudoboehmite flame-retardant ceramic, and 60 wt % of a polyether polyol binder were mixed in a toluene solvent to prepare a composition for an elastic sheet.

### Example 6

An all-solid-state battery cell was fabricated by the same procedure as in Example 1, except that 30 wt % of a plate-shaped polyethylene particle with an aspect ratio of 1.5, a thickness of 0.8 μm, and a size D50 of 6 μm, 10 wt % of a pseudoboehmite flame-retardant ceramic, and 60 wt % of a polyether polyol binder were mixed in a toluene solvent to prepare a composition for an elastic sheet.

### Example 7

An all-solid-state battery cell was fabricated by the same procedure as in Example 1, except that 30 wt % of a plate-shaped polyethylene particle with an aspect ratio of 1.8, a thickness of 0.5 μm, and a size D50 of 6 μm, 10 wt % of a pseudoboehmite flame-retardant ceramic, and 60 wt % of a polyether polyol binder were mixed in a toluene solvent to prepare a composition for an elastic sheet.

### Example 8

An all-solid-state battery cell was fabricated by the same procedure as in Example 1, except that 30 wt % of a plate-shaped polyethylene particle with an aspect ratio of 1.8, a thickness of 0.8 μm, and a size D50 of 6 μm, 10 wt % of a pseudoboehmite flame-retardant ceramic, and 60 wt % of a polyether-based polyol binder were mixed in a toluene solvent to prepare a composition for an elastic sheet.

### Comparative Example 1

### (1) Preparation of Elastic Sheet

30 wt % of polyurethane particles, 10 wt % of pseudoboehmite flame-retardant ceramic, and 60 wt % of polyether polyol binder (functionality: 3, number average molecular weight: 3000 g/mol) were mixed in a toluene solvent to prepare a composition for an elastic sheet.

The resulting mixture was coated on a polyethylene terephthalate (PET) film as a release film and was irradiated with ultraviolet (UV) with a light quantity of 2000 mJ/cm² to prepare an elastic sheet adhered on the PET film.

An all-solid-state battery cell was fabricated by the same procedure as in Example 1, using the elastic sheet.

### Comparative Example 2

An all-solid-state battery cell was fabricated by the same procedure as in Example 1, except that 40 wt % of a plate-shaped polyethylene particle with an aspect ratio of 5.5, a thickness of 0.5 μm, and a size D50 of 6 μm and 60 wt % of a polyether-based polyol binder were mixed in a toluene solvent to prepare a composition for an elastic sheet.

### Comparative Example 3

An all-solid-state battery cell was fabricated by the same procedure as in Example 1, except that 40 wt % of a plate-shaped polyethylene particle with an aspect ratio of 5.5, a thickness of 0.8 μm, and a size D50 of 6 μm and 60 wt % of a polyether-based polyol binder were mixed in a toluene solvent to prepare a composition for an elastic sheet.

### Comparative Example 4

An all-solid-state battery cell was fabricated by the same procedure as in Example 1, except that 40 wt % of a plate-shaped polyethylene particle with an aspect ratio of 1.5, a thickness of 0.1 μm, and a size D50 of 6 μm and 60 wt % of a polyether-based polyol binder were mixed in a toluene solvent to prepare a composition for an elastic sheet.

### Comparative Example 5

An all-solid-state battery cell was fabricated by the same procedure as in Example 1, except that 40 wt % of a plate-shaped polyethylene particle with an aspect ratio of 1.8, a thickness of 1 μm, and a size D50 of 6 μm and 60 wt % of a polyether-based polyol binder were mixed in a toluene solvent to prepare a composition for an elastic sheet.

### Comparative Example 6

An all-solid-state battery cell was fabricated by the same procedure as in Example 1, except that 30 wt % of the plate-shaped polyethylene particle having an aspect ratio of 5.5, a thickness of 0.5 μm, and a size of 6 μm, 10 wt % of pseudoboehmite flame-retardant ceramic, and 60 wt % of the polyether-based polyol binder were mixed in a toluene solvent to prepare a composition for an elastic sheet.

### Experimental Example 1) Evaluation of Stress Relaxation Ratio

The stress relaxation ratio for the elastic sheets of Examples 1 to 8 and Comparative Examples 1 to 6 was evaluated. The results are shown in Table 1. The stress relaxation ratio was measured by primarily compressing the elastic sheet under a pressurization condition of 2.5 kgf, immediately secondarily compressing it at 40 μm to measure initial stress, and maintaining it for 60 seconds after secondary compression to measure stress to calculate using Equation 2.

Stress relaxation ratio (%)=(Stress after 60 seconds after 40 μm compression)/(initial stress at 40 μm)×100. [Equation 2]

### Experimental Example 2) Evaluation of Recovery Ratio

The recovery ratio for the elastic sheet of Examples 1 to 8 and Comparative Examples 1 to 6 were evaluated (see Table 1).

The recovery ratio was measured by primarily compressing the elastic sheet under a pressurization condition of 2.5 kgf, immediately secondarily compressing it at 40 μm, and maintaining it for 60 seconds to measure the initial stress at the time of the first compression and the stress at the time of returning to the secondary starting point (initial point) to calculate it according to Equation 3.

Recovery ratio (%)=(Stress at the time restoration to initial point after 40 μm)/(Initial stress at 40 μm compression)×100. [Equation 3]

### Experimental Example 3) Evaluation of Cycle-Life

The all-solid-state battery cells of Examples 1 to 8 and Comparative Examples 1 to 6 were inserted into a test module and fixed with a force of 5000 gf, and then charged at a constant current of 0.1 C at 45° C. to the upper voltage limit of 4.25 V and discharged at 0.1 C to the cut-off voltage of 2.5 V to perform initial charge and discharge.

The cells initial charging and discharging were charged and discharged at 0.33 C in the voltage range of 2.5 V to 4.25 V at 45° C. for 300 cycles, and the number of cycles at which the discharge capacity relative to the initial discharge capacity was dropped to less than 90% was considered as the cycle-life. The results are shown in Table 1.

### Experimental Example 4) Nail Penetration Test

The all-solid-state battery cells according to Examples 1 to 8 and Comparative Examples 1 to 6 which were fully charged, were penetrated by a stainless nail with a diameter of 3 mm and then the temperature of the cell center where penetration occurred was measured using a thermocouple. The nail penetration test was carried out at 25° C. and a penetration speed was set to as 50 mm/s.

The results are shown in Table 1 below.

TABLE 1

| | Stress | | | Temperature after |
|---|---|---|---|---|
| | relaxation | Recovery | cycle-life | penetrating |
| | ratio (%) | ratio (%) | (Cycle) | nail (° C.) |
| Example 1 | 18 | 84 | −260 | <40 |
| Example 2 | 17 | 81 | −240 | <40 |
| Example 3 | 18 | 82 | −240 | <40 |
| Example 4 | 17 | 82 | −230 | <40 |
| Example 5 | 16 | 78 | −210 | <30 |
| Example 6 | 16 | 79 | −210 | <30 |
| Example 7 | 15 | 77 | −220 | <30 |
| Example 8 | 16 | 78 | −200 | <30 |
| Comparative | 2 | 87 | −180 | −70 |
| Example 1 | | | | |
| Comparative | 15 | 73 | −200 | −45 |
| Example 2 | | | | |
| Comparative | 16 | 75 | −200 | −45 |
| Example 3 | | | | |
| Comparative | 16 | 74 | −210 | −45 |
| Example 4 | | | | |
| Comparative | 16 | 71 | −200 | −45 |
| Example 5 | | | | |
| Comparative | 14 | 70 | −190 | −40 |
| Example 6 | | | | |

As shown in Table 1, the all-solid-state battery cells of Examples 1 to 8 exhibited excellent stress relaxation ratios, recovery ratio and long cycle-life characteristics, and low temperature after penetrating a nail indicating excellent safety.

Whereas, Comparative Example 1 exhibited extremely low stress relaxation ratio and low cycle-life characteristics, and high temperature after penetrating a nail indicating poor safety.

Comparative Examples 2 to 6 exhibited low cycle-life characteristics and degraded safety.

From these results, using the plate polymer having an aspect ratio of 1 to 5 and a thickness of 0.2 μm to 4 μm in the elastic sheet may exhibit excellent electrochemical characteristics and safety.

One or more embodiments provide an elastic sheet for an all-solid-state battery which is capable of applying uniform pressure to an electrode assembly and simultaneously improving safety in an internal short-circuit.

Another embodiment provides an all-solid-state battery including the elastic sheet.

One or more embodiments provide an all-solid-state battery for an all-solid-state battery including a plate-shaped polymer with an aspect ratio of about 1 to about 5 and a thickness of about 0.2 μm to about 4 μm; and a binder.

Another embodiment provides an all-solid-state solid-state battery including a positive electrode, a negative electrode, a solid electrolyte layer between the positive electrode and the negative electrode, and the elastic sheet positioned on an outside of at least one of the positive electrode and the negative electrode.

An elastic sheet according to one or more embodiments may uniformly apply pressure to an electrode assembly and may provide an all-solid-state battery exhibiting excellent safety in occurring the internal short-circuit.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An elastic sheet for an all-solid-state battery, the elastic sheet comprising:
a plate-shaped polymer with an aspect ratio of about 1 to about 5 and a thickness of about 0.2 μm to about 4 μm; and
a binder.

2. The elastic sheet for an all-solid-state battery as claimed in claim 1, wherein the aspect ratio is about 1.1 to about 4.5.

3. The elastic sheet for an all-solid-state battery as claimed in claim 1, wherein the thickness is about 0.3 μm to about 2.5 μm.

4. The elastic sheet for an all-solid-state battery as claimed in claim 1, wherein the plate-shaped polymer comprises polyethylene particles.

5. The elastic sheet for an all-solid-state battery as claimed in claim 1, wherein the plate-shaped polymer has a size of about 1 μm to about 8 μm.

6. The elastic sheet for an all-solid-state battery as claimed in claim 1, wherein an amount of the plate-shaped polymer is about 10 wt % to about 70 wt % based on a total weight of the elastic sheet.

7. The elastic sheet for an all-solid-state battery as claimed in claim 1, further comprising a flame-retardant ceramic.

8. The elastic sheet for an all-solid-state battery as claimed in claim 7, wherein the flame-retardant ceramic comprises aluminum hydroxide, boehmite, pseudoboehmite, magnesium hydroxide, or a combination thereof.

9. The elastic sheet for an all-solid-state battery as claimed in claim 7, wherein a mixing ratio of the plate-shaped polymer and the flame-retardant ceramic is about 9:1 to about 7:3 by weight.

10. An all-solid-state battery, comprising:
a positive electrode;
a negative electrode;
a solid electrolyte layer between the positive electrode and the negative electrode; and
an elastic sheet, comprising:
a plate-shaped polymer with an aspect ratio of about 1 to about 5 and a thickness of about 0.2 μm to about 4 μm; and
a binder, positioned on outside of at least one of the positive electrode and the negative electrode.

11. The all-solid-state battery as claimed in claim 10, wherein the aspect ratio of the elastic sheet is about 1.1 to about 4.5.

12. The all-solid-state battery as claimed in claim 10, wherein the thickness of the elastic sheet is about 0.3 μm to about 2.5 μm.

13. The all-solid-state battery as claimed in claim 10, wherein the plate-shaped polymer of the elastic sheet comprises polyethylene particles.

14. The all-solid-state battery as claimed in claim 10, wherein the plate-shaped polymer of the elastic sheet has a size of about 1 μm to about 8 μm.

15. The all-solid-state battery as claimed in claim 10, wherein an amount of the plate-shaped polymer is about 10 wt % to about 70 wt % based on a total weight of the elastic sheet.

16. The all-solid-state battery as claimed in claim 10, wherein the elastic sheet further comprises a flame-retardant ceramic.

17. The all-solid-state battery as claimed in claim 16, wherein the flame-retardant ceramic comprises aluminum hydroxide, boehmite, pseudoboehmite, magnesium hydroxide, or a combination thereof.

18. The all-solid-state battery as claimed in claim 16, wherein a mixing ratio of the plate-shaped polymer and the flame-retardant ceramic is about 9:1 to about 7:3 by weight.
